(19) United States
(12) Patent Application Publication
(10) Pub. No.: US 2021/0105988 A1
(43) Pub. Date: Apr. 15, 2021

(54) COLOR-CODED SALTWATER FLY FISHING LEADER

(71) Applicant: Ron Sagalowsky, Indianapolis, IN (US)

(72) Inventor: Ron Sagalowsky, Indianapolis, IN (US)

(21) Appl. No.: 16/930,781

(22) Filed: Jul. 16, 2020

Related U.S. Application Data
(60) Provisional application No. 62/921,935, filed on Jul. 16, 2019.

(51) Int. Cl. A01K 91/16

(52) U.S. Cl. CPC A01K 91/16

(57) ABSTRACT

A fly-fishing leader assembly, including a first double-strand braided length having a first proximal end and a first distal end, wherein the first proximal end is color-coded indicative of breaking strength of the first double-strand braided length, a second single strand length having a second proximal end and a second distal end, wherein the first distal end and the second proximal end are knotted together in a first knot, and an elongated hollow tube member for enclosing at least a portion of the second single strand length. The fly-fishing leader assembly has a proximal end and a distal end. The elongated hollow tube member is color coded at each respective end indicative of the breaking strength of the fly-fishing leader assembly at either end.

### CROSS-REFERENCE TO RELATED APPLICATIONS

This patent application claims priority to co-pending U.S. Provisional Patent Application Ser. No. 62/921,935 filed on Jul. 16, 2019.

### BACKGROUND

Fly fishing is an activity that involves the use of a reel, a rod, fishing line, and an artificial fly that serves as the lure or bait. The connection of the fly line to the fly is achieved by a specialized segment of line. This specialized line segment is usually made of monofilament or, occasionally, of fluorocarbon. The specialized line segment may also consist of both mono and fluorocarbon. By common parlance, this specialized line segment connecting the fly line to the fly is referred to as the leader.

At one end, the leader begins of a relatively large diameter and subsequently high strength appropriately matching tat of the chosen fly line. The leader then enjoys a gradual reduction in diameter; this is referred to as the taper of the leader. In saltwater fly fishing, this taper is incremental rather than smooth, and is achieved by connecting several pieces of progressively smaller diameter, and usually of lesser strength, material (monofilament and or fluorocarbon). By common usage special knots are utilized to accomplish this end, such as the Blood Knot, Bimini, Huffnagle, Bristol, Albright, Uniknot and the like.

Once assembled, the complete leader is commonly considered to consist of three sections: (1) the butt, (2) the transition zone, and (3) the tippet. The tippet is the thinnest and weakest segment of the complete leader. The thickest and strongest segment is the butt, which attaches at one end to the fly line and at the other end to the transition zone. The transition zone attaches at one to the butt and at the opposite end to the tippet. Likewise, the tippet attaches at one end to the transition zone and at the other end to the fly. The breaking strength of the weakest section defines the class of the entire leader system and is expressed in pounds. The class represents the breaking strength of the tippet as well as that of the leader system.

The International Game Fish Association (IGFA) is the official governing body for all gamefish record keeping. The IGFA has designated the following class to be legal for the recording of fish caught: 2 lb., 4 lb., 6 lb., 8 lb., 12 lb., 16 lb. and 20 lb. Most fly fishers conform to these class designations when configuring a leader. Additionally, the IGFA has requirements regarding the length of each section of the leader.

In saltwater fly fishing, an additional heavy piece of material is allowed to be added to the class tippet before its attachment to the fly. This additional piece of material is called the shock or trace tippet. It may be of any material and of any strength. However, the shock may be no more than 12 inches in length to conform with IGFA regulations.

Saltwater fly fisherman typically tie their own leaders as needed by chaining together a butt, a transition, and a tippet using line segments of progressively narrower diameter and lesser strength. Even for experienced fishermen, this process can be time consuming and tedious. Further, as fishing is a dynamic sport with changing conditions and with widows of opportunity prone to suddenly opening and just a suddenly closing, the as-needed construction of the right leader can often cost the fisherman his prize catch of the day. Frequent changes of the leader become necessary for a variety of reasons: change of fly, damage to some portion of the leader, desire to fish for a different species of fish, change in conditions of wind, visibility, or water clarity to name a few but not all. Furthermore, the need for a change of leader often arises in less than optimal conditions. The time required to make a change of leader is of importance as the moment of opportunity is often fleeting.

Thus, there remains a need for an improved leader system. The present novel technology addresses this need.

### DESCRIPTION OF THE DRAWINGS

FIG. 1 is a first perspective view of a first embodiment coded leader line of the present novel technology.

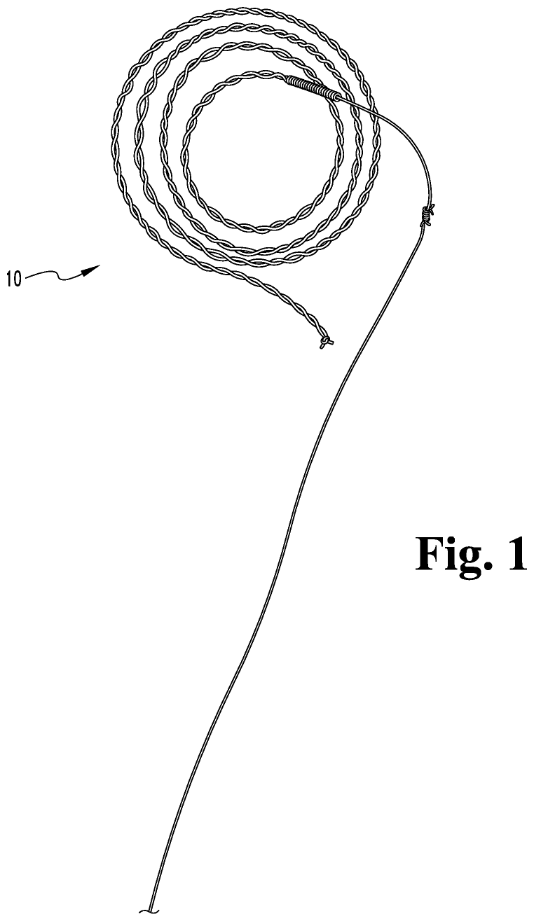

FIG. 2 is a perspective view of the leader line of FIG. 1 enjoying a coded cylindrical clear plastic protector sheath.

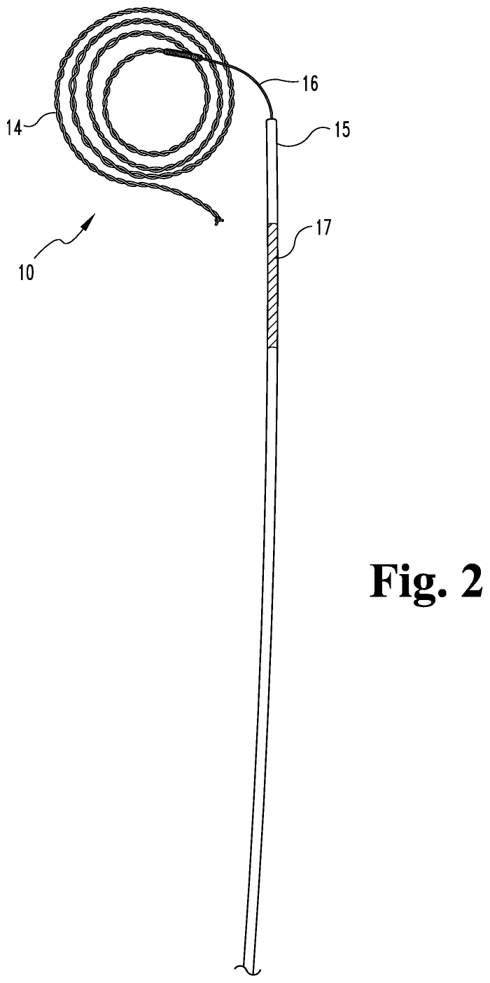

FIG. 3 is a perspective view of the leader line assembly of FIG. 2 inserted into protective packaging.

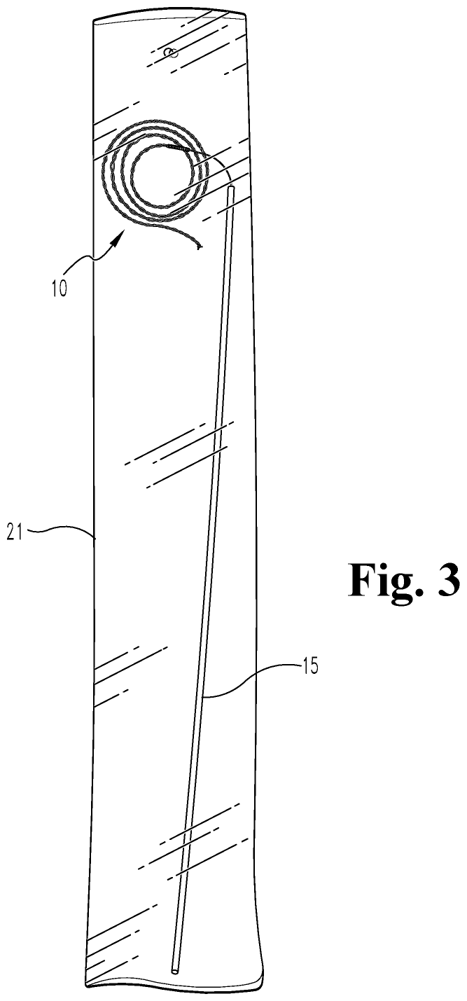

FIG. 4 is a perspective view of the coded sheath of FIG. 2.

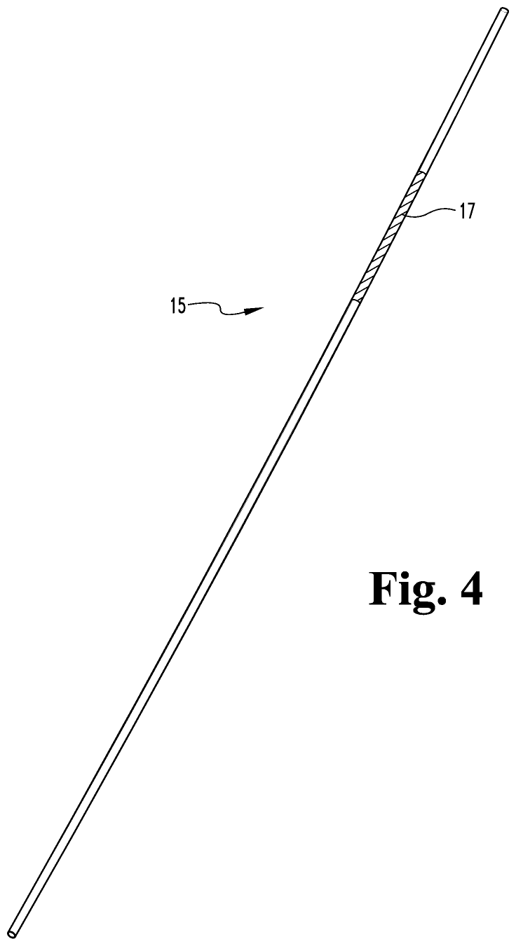

FIG. 5 is a top plan view of the coded leader line of FIG. 1.

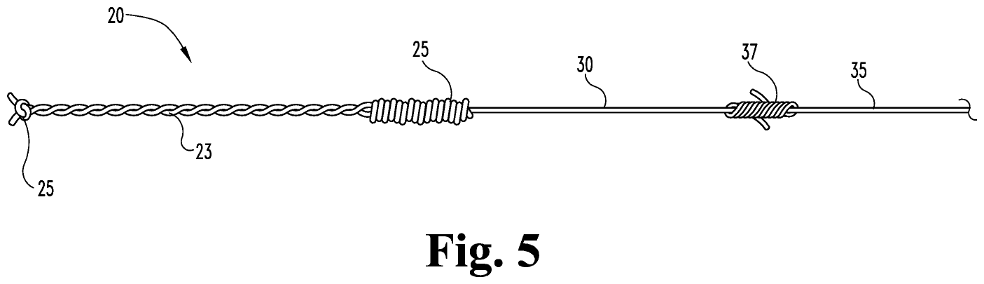

FIG. 6 is a top plan view of several color-coded leader lines.

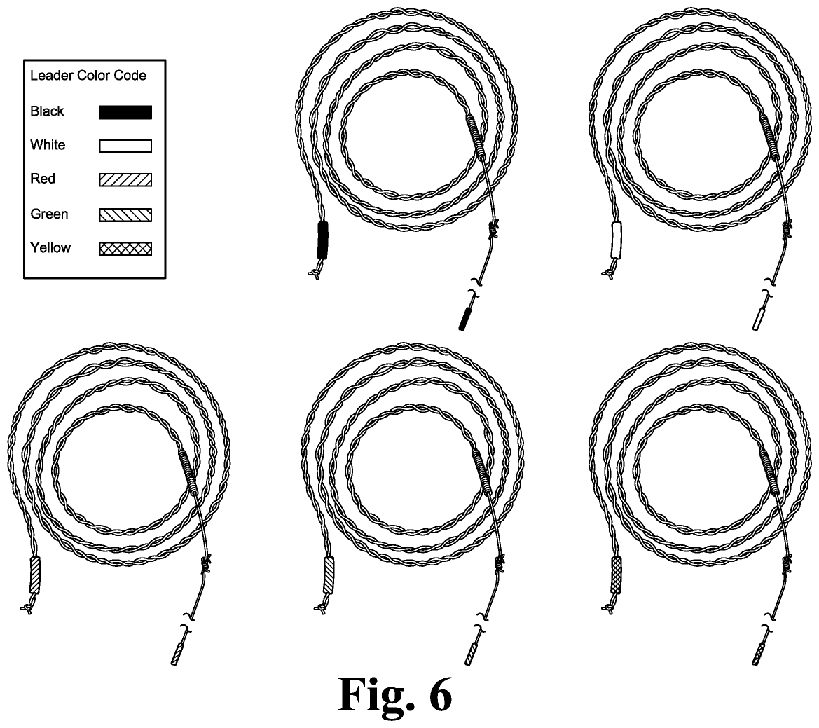

### DESCRIPTION OF PREFERRED EMBODIMENTS

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

The present novel technology relates to a pre-tied leader assembly 10 that is inserted into a protective sleeve 15 and color coded 17 for easy identification. The leader assembly 10 may include the butt segment 12, the transition segment 14, the tippet segment 16, connected sequentially, but typically only includes a transition 14 and a connected tippet 16.

The leader system 10 typically consists of between about twenty-four to about thirty inches of a braid 20 or furled line. The braid 20 is typically formed from two strands 23 of a line of a desired class and is typically secured by means of a Bimini Twist or like knot 25. The braid 20 is continuous with a fifteen to twenty-inch segment 30 of single strand class leader material. This single strand class segment 30 is typically attached to the shock tippet 35, if present, by a Blood knot, a Huffnagle knot, a Slim Beauty knot, back to back Uniknots, or the like 37. The leader 10 is color-coded 17 at the end of the transition zone 14 that attaches to the butt 12 and at the end of the shock 35 where the shock attaches to the fly 40. In a fishing situation, the process of attaching the leader 10 to the butt 12 and the fly 40 results in these colored portions 19 being discarded as waste and thus, the colored portions 19 do not serve as a distraction to the fish.

Coloring the ends 19 of the transition segment 14/class segment 30 and shock 35/tippet segment 16 may be accomplished by one of several methods: (1) dying the monofilament and fluorocarbon portions 14,16,30,35 by a thirty minute emersion in a food-dye solution that has previously been brought to a boil, (2) using fabric dye, (3) dipping colored wax (parafin), (4) by the use of colored markers, and/or (5) any like convenient coloring technique.

One example color-coding schema is as follows:

green for 12 lb. class and 40 lb. shock;

red for 16 lb. class and 60 lb. shock;

purple for 20 lb. class and 80 lb. shock;

orange is reserved for #20 shock.

The class tippet remains uncolored if lighter than 12 lb. but rather leave it clear as it comes from the manufacturer.

Typically, a chart explaining the color code is provided with each leader unit 10 or kit.

In one embodiment, a selection of color-coded leader assemblies 10 is provided as a kit 100. The kit 100 typically includes an assortment of leaders 10 in various IGFA approved combinations of class 30 and shock tippets 35. A typical kit might include twelve pound to forty pound leaders 10; sixteen pound to forty pound leaders 10; sixteen pound to forty pound leaders 10; sixteen to sixty pound leaders 10; sixteen pound to forty pound leaders 10; sixteen pound to sixty pound leaders 10; twelve pound to sixty pound leaders 10; twenty pound to eighty pound leaders 10; ten pound with no shock leaders 10; eight pound with no shock leaders 10; twelve pound with no shock leaders 10; and twelve, sixteen, and/or twenty pound class to twenty-seven to thirty pound wire leaders 10. The material for the class tippet 16 is monofilament or fluorocarbon. The material for the shock 35 may be monofilament, fluorocarbon or wire.

Typically, each leader assembly 10 is enclosed in a clear plastic tube or sleeve 15. The tube 15 is typically about eighteen inches long and has a diameter of about 0.21 inches. The tube 15 surrounds the shock portion 35 of the leader system 10 to prevent kinking or abrading the shock 35 before its use. The clear plastic tube 15 is also color coded 17. In some embodiments, the tube/sleeve is made of paper. The entire assembly of leader 10 within tube 15 is typically individually packaged in a clear sleeve 21.

In operation, the leader 10 is assembled by measuring twelve feet of monofilament of the desired class, and then dividing this length of line in half to create a loop, each leg of which is six feet in length. One leg is folded back on itself creating a smaller loop each leg of which is three feet in length, continuous with six feet of the original single strand. This is accomplished by fashioning a Bimini knot at the junction of the second loop and single strand. The three-foot loop is cut at its end creating two three foot strands each connected to the single strand of monofilament which is six feet in length, by the Bimini knot.

The Bimini knot is secured so it does not twist further. Each single three-foot strand is individually twisted 80-100 times. Each strand is rotated in the same direction individually, not together. These two twisted ends of the three-foot sections are tied to each other at their ends, such as by using a simple double overhand knot. Moderate tension in opposite directions is maintained on the Bimini knot and the overhand knot to maintain separation of the ends of the leader 10. The twisted three-foot sections are typically allowed to unwind on their own. The result is a braid (furled line) approximately three feet in length continuous with the single strand six feet in length. The class tippet and transition zone so formed is attached to the shock tippet by means of an Improved Blood knot, a Huffnagle a Slim Beauty knot, back to back Uniknots, or the like.

Color coding reduces the time necessary to choose and change leaders. The ability of the angler to more easily and more quickly identify the correct leader for a particular fishing situation greatly increases the fly fisher's efficiency and productivity. A leader system less visible to the fish is much more likely to result in the fish taking the fly.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

I claim:

1. A fly-fishing leader assembly, comprising:
a first double-strand braided length having a first proximal end and a first distal end, wherein the first proximal end is color-coded indicative of breaking strength of the first double-strand braided length;
a second single strand length having a second proximal end and a second distal end, wherein the first distal end and the second proximal end are knotted together in a first knot; and
an elongated hollow tube member for enclosing at least a portion of the second single strand length;
wherein the fly-fishing leader assembly has a proximal end and a distal end; and
wherein the elongated hollow tube member is color coded at each respective end indicative of the breaking strength of the fly-fishing leader assembly at either end.

2. The fly-fishing leader assembly of claim 1 wherein the second distal end is color coded indicative of breaking strength of the second single strand.

3. The fly-fishing leader assembly of claim 1 and further comprising:
a third single strand length having a third proximal end and a third distal end;
wherein the third proximal end is knotted to the second distal end in a second knot; and
wherein the third distal end is color-coded indicative of breaking strength of the third single strand.

4. The fly-fishing leader assembly of claim 1 and further comprising:
a protective sleeve enclosing the fly-fishing leader assembly.

5. A fly-fishing leader assembly kit, comprising:
a first plurality of first pre-tied flu fishing leader assemblies;
a second plurality of second pre-tied fly-fishing leader assemblies; and
a third plurality of third pre-tied fly-fishing leader assemblies;
each respective pre-tied flu fishing leader assembly further comprising:
a first double-strand braided length having a first proximal end and a first distal end, wherein the first proximal end is color-coded indicative of breaking strength of the first double-strand braided length;
a second single strand length having a second proximal end and a second distal end, wherein the first distal end and the second proximal end are knotted together in a first knot; and
an elongated hollow tube member for enclosing at least a portion of the second single strand length;
wherein the fly-fishing leader assembly has a proximal end and a distal end; and
wherein the elongated hollow tube member is color coded at each respective end indicative of the breaking strength of the fly-fishing leader assembly at either end;
wherein each respective first pre-tied fly-fishing leader assembly has a first proximal end breaking strength;
wherein each respective second pre-tied fly-fishing leader assembly has a second proximal end breaking strength different from the first proximal end breaking strength;
wherein each respective third pre-tied fly-fishing leader assembly has a first proximal end breaking strength different from the first proximal end breaking strength and the second proximal end breaking strength.
